(19) United States
(12) Patent Application Publication
(10) Pub. No.: US 2021/0213417 A1
(43) Pub. Date: Jul. 15, 2021

(54) Carbon Monoliths and a Process for Producing Same

(71) Applicant: Monash University, Clayton, Victoria (AU)

(72) Inventors: Mohammad Reza Parsa, Clayton, Victoria (AU); Alan Loyd Chaffee, Clayton, Victoria (AU)

(73) Assignee: Monash University, Clayton, Victoria (AU)

(21) Appl. No.: 17/058,928

(22) PCT Filed: May 25, 2018
(86) PCT No.: PCT/AU2018/050507

§ 371 Date: Nov. 25, 2020

(30) Foreign Application Priority Data
May 26, 2017 (AU) 2017901992

(51) Int. Cl. B01J 20/20; B01J 20/28; B01J 20/30; B01J 19/14; C01B 32/336; C01B 32/318; C01B 32/354

(52) U.S. Cl. CPC B01J 20/20; C01P 2006/40; B01J 20/3007; B01J 20/3014; B01J 20/3078; B01J 20/3071; B01J 20/28061; B01J 20/28064; B01J 20/28011; B01J 20/3042; B01J 19/14; C01B 32/336; C01B 32/318; C01B 32/354; B01J 2220/42; C01P 2002/01; C01P 2002/82; C01P 2002/85; B01J 20/28045

(57) ABSTRACT

A carbon monolith and a process of producing same, the process comprising the steps of: (i) mixing a carbonaceous precursor material with an alkali salt to form a first mixture; (ii) extruding the first mixture produced in step (i) into the shape of a monolith; and (iii) carbonizing the monolith produced in step (ii).

### TECHNICAL FIELD

The present invention generally relates to carbon monoliths and in particular to carbon monoliths with internal channels such as carbon honeycomb monoliths, formed from carbonaceous materials with a relatively high moisture and oxygen content such as low rank coals. Also disclosed is a process for producing carbon monoliths.

### BACKGROUND

Carbon monoliths are a unitary structure formed from carbon or have a surface comprising carbon. Such monoliths may have an activated carbon surface and may be a solid structure or have one or more internal channels with high surface area.

Honeycomb monoliths are monolithic materials with long parallel passages separated by thin walls. Honeycomb monoliths are so-named due to their resemblance to the construction of beehives, although the channel may have a cross section of any practical shape, most commonly circular or square. Honeycomb monoliths are most usually formed by the extrusion of a pliable dough that is processed to form a mechanically robust product.

Honeycomb monoliths have found particular application as adsorbents and catalyst supports. Honeycomb monoliths are advantageous over powered or pellet type adsorbents and catalysts as the high void fraction inherent in honeycomb monoliths reduces the pressure drop when a high flowrate is applied across the monolith. The structure of the honeycomb monoliths may also promote better contact efficiency than clusters of packed media in purification and separation applications. Honeycomb monoliths are commonly used in a variety of environmental applications such as automobile exhaust treatment, ozone abatement in aircraft, natural gas engines, CO and hydrocarbon oxidation in small engines as well as the selective reduction of NOₓ and the destruction of volatile organic compounds (VOC) from chemical plants and domestic sources.

Honeycomb monoliths known to the art are of two main types: coated monoliths and integral monoliths. Coated monoliths are usually fabricated from a substrate material that provides mechanical strength which is coated with a functional layer. The substrate material is usually formed from an extruded ceramic dough, most typically cordierite, mixed other processing additives followed by drying and calcination. The substrate material may then be subjected to a series of washcoats to improve the low surface area, which is typically in the order of 2-4 m²/L, and to provide a functional surface, for example an absorbent or catalyst surface.

Because the coated monoliths require a substrate material solely for mechanical strength, the volume that the substrate material occupies is not useful for the functional purpose of the monolith. This difficulty is overcome by integral monoliths which are produced from a single formulation that provides both mechanical strength and a functional surface. However, few materials are available that can form a monolith with suitable mechanical strength as well as a functional surface.

Carbon is an example of a material that may be used as an integral monolith. Activated carbon honeycomb monoliths have a wide variety of uses in gas and liquid phase adsorption, as well as in catalyst applications and as electrode materials. Activated carbon monoliths offer a number of advantages over powdered or pelleted activated carbon in addition to pressure drop characteristics. In gas phase adsorption applications, activated carbon monoliths may be used in the electrical swing adsorption (ESA) process, where the monolith can be quickly regenerated by facile application of electric current. For liquid phase applications, activated honeycomb monoliths may offer high efficiency adsorption in a flow through configuration.

Integral carbon honeycomb monoliths can be prepared from a dough formed from expensive resin precursors, usually with the addition of binders to for a dough. This dough may then be extruded into the honeycomb shape, carbonised and activated. Integral carbon monoliths may also be formed from a dough of activated carbon powder mixed with binders, however this method usually requires large amounts of binder to form a monolith with sufficient mechanical strength.

Accordingly, there is a need to provide an integral carbon monolith with internal channels that may be formed from relatively inexpensive precursor materials and that possesses good mechanical properties as well as good surface characteristics. There is a further need to produce such a carbon monolith in the shape of a honeycomb monolith which may also display good electrical conductivity.

It has been surprisingly found that carbonaceous materials with high moisture and oxygen content, such as lignite and peat, may be formed into a dough with an alkali salt and processed into a honeycomb monolith with good mechanical and surface properties as well as good electrical conductivity.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### BRIEF SUMMARY

The present invention seeks to provide an invention with improved features and properties.

According to a first aspect, the present invention provides a process to produce a carbon monolith comprising the steps of: (i) mixing a carbonaceous precursor material with an alkali salt to form a first mixture; (ii) extruding the first mixture produced in step (i) into the shape of a monolith; (iii) carbonizing the monolith produced in step (ii).

According to a further aspect, the present invention provides the process according to the first aspect, wherein the carbon monolith is adapted with one or more internal channels.

According to a further aspect, the present invention provides the process according to the first aspect, wherein the carbon monolith is a honeycomb monolith.

According to a further aspect, the present invention provides the process according to the first aspect, wherein the carbonaceous precursor material has an oxygen content of at least 10 wt % and a moisture content of at least 20 wt %.

According to a further aspect, the present invention provides the process according to the first aspect, wherein the carbonaceous precursor material is selected from brown coal, lignite, peat or biomass.

According to a further aspect, the present invention provides the process according to the first aspect, wherein the carbonaceous precursor material is Victorian Brown Coal.

According to a further aspect, the present invention provides the process according to the first aspect, wherein the carbonization step includes heating the monolith at a heating rate ranging from about 0.5° C. to about 15° C. per minute.

According to a further aspect, the present invention provides the process according to the first aspect, wherein the carbonization step includes heating the monolith to a temperature of between about 700° C. to about 1200° C.

According to a further aspect, the present invention provides the process according to the first aspect, wherein the carbonization step (iii) is performed in an inert atmosphere.

According to a further aspect, the present invention provides the process according to the proceeding aspect, wherein the carbonization step (iii) is performed in an atmosphere substantially comprising nitrogen.

According to a further aspect, the present invention provides the process of the first aspect, comprising a further step of physically activating the carbonized monolith produced in step (iii).

According to a further aspect, the present invention provides the process of the first aspect, wherein the further step of physically activating the carbonized monolith includes heating the carbonized monolith to a temperature of between about 800° C. and about 1200° C.

According to a further aspect, the present invention provides the process according to the proceeding aspect, wherein the activation step includes contacting the carbon monolith with an atmosphere comprised substantially of CO₂ and/or steam.

According to a further aspect, the present invention provides the process according to the first aspect, wherein the first mixture further includes a supplementary additive to facilitate extrusion.

According to a further aspect, the present invention provides the process according to the first aspect, wherein the supplementary additive is selected from glycerol, paraffin oil, methylcellulose powders and/or Methocel™.

According to a further aspect, the present invention provides the process according to the first aspect, wherein the first mixture further includes an additional additive to customise the performance of the subsequently formed carbon monolith.

According to a further aspect, the present invention provides the process according to the first aspect, wherein the additional additive is selected from iron II and III compounds and nitrogen containing compounds including urea and/or melamine.

According to a further aspect, the present invention provides the process according to the first aspect, comprising a further step of conditioning the extruded dough produced in step (ii) before the carbonization step (iii).

According to a further aspect, the present invention provides the process according to the first aspect, comprising a further step of pre-oxidizing the monolith before or after the carbonization step (iii).

According to a further aspect, the present invention provides the process according to the first aspect, comprising a further step of acid washing the monolith after the carbonization step (iii).

According to a further aspect, the present invention provides the process according to the first aspect, wherein the alkali salt is selected from any suitable salt of an alkali metal or an alkali earth metal or a combination of same.

According to a further aspect, the present invention provides the process according to the first aspect, wherein the alkali salt is selected from a hydroxide, carbonate or bicarbonate salt of an alkali metal or an alkali earth metal or a combination of same.

According to a further aspect, the present invention provides the process according to the first aspect, wherein the alkali salt is selected from LiOH, NaOH, KOH, Mg(OH)2 or Ca(OH)2 or a combination of same.

According to a further aspect, the present invention provides a carbon monolith formed by the process of any one of the above aspects.

According to a second aspect, the present invention provides a carbon monolith formed from an extruded mixture of an alkali salt and a carbonaceous precursor material with a moisture content of at least 20 wt % and a oxygen content of at least 10 wt %.

According to a further aspect, the present invention provides the process according to the second aspect, wherein the extruded mixture is carbonized and activated.

According to a further aspect, the present invention provides the process according to the second aspect, wherein the carbonaceous precursor material and the alkali salt are kneaded together prior to extrusion thereby facilitating ion-exchange between the carbonaceous precursor material and the alkali salt.

According to a further aspect, the present invention provides the process according to the second aspect, wherein the carbonaceous precursor material is Victorian Brown Coal.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates carbon monoliths of the present invention before and after carbonisation;

FIG. 2 illustrates a view of a carbon monolith according to the present invention;

FIG. 3 illustrates a Raman spectra of a sample carbon monolith according to the present invention;

FIG. 4 illustrates the results of a mercury porosimetry analysis of a sample carbon monolith according to the present invention;

FIG. 5 illustrates a Transmission Electron Microscopy (TEM) image of a sample of a carbon monolith according to the present invention; and,

FIG. 6 illustrates an XPS analysis of a carbon monolith according to the present invention.

### PREFERRED EMBODIMENTS

The following modes, given by way of example only, are described in order to provide a more precise understanding of the subject matter of a preferred embodiment or embodiments.

Described herein is a carbon monolith with one or more internal channels, such as a carbon honeycomb monolith, formed from an extruded mixture of a carbonaceous precursor material and an alkali salt. Also described herein is a process to produce a carbon monolith with one or more internal channels, such as a carbon honeycomb monolith, from an extruded mixture of a carbonaceous precursor material and an alkali salt.

By way of definition, a monolith refers to a unitary structure and a honeycomb monolith refers to a unitary structure that is internally traversed by multiple passages separated by a thin wall.

The honeycomb monolith may be produced from a carbonaceous precursor material with a relatively high oxygen and moisture content. The honeycomb monolith may be produced from a carbonaceous precursor material with a oxygen and moisture content selected from at least about 20 wt % and 10 wt % respectively. Examples of material that may posses the requisite moisture and oxygen content are brown (low rank) coal, lignite, peat and some forms of biomass. Victorian brown coal (VBC) is a low rank coal deposited extensively in the Australia state of Victoria, and typically has a high moisture content of approximately 50-67 wt % and a high oxygen content of approximately 25 to 30 wt % dry ash free (daf).

In a particular non-limiting embodiment, described herein is an activated carbon honeycomb monolith formed from Victorian brown coal (VBC), as well as a process for producing the same. It is to be understood that monoliths of other shapes and formed of other carbonaceous precursor materials fall within the scope of the present disclosure.

The honeycomb monolith may be formed by first mixing a carbonaceous precursor material with an alkali salt to form a first mixture termed the dough. In a broad aspect, the dough may be subsequently extruded into the general shape of the honeycomb monolith and then dried/conditioned and carbonised to produce a carbon honeycomb monolith. The size of the monolith may decrease between being extruded and being carbonised due to the loss of moisture and volatiles from the monolith. However, the overall shape and geometry may remain substantially similar and intact. In the embodiments herein described, the carbon monoliths may be configured such that activated carbon is formed during the carbonisation step due to the presence of the alkali salt. A further physical activation step may be performed after the monoliths have been carbonised to further activate the carbon.

The alkali salts may be any suitable salt of an alkali metal or alkali earth metal (i.e. periodic table group 1 and group 2 metals) with common examples being LiOH, NaOH, KOH, Mg(OH)₂ and Ca(OH)₂. The carbonate and bicarbonate salts of the alkali metals and alkali earth metals may also be suitable. Salts involving the ammonium cation may be ineffective in some circumstances as the ammonium cation may be thermally unstable.

The mixing of the brown coal and the alkali salt may be performed by kneading these materials together to form a homogenous pliable dough. The kneading process may involve a shearing process which may breakdown the residual cellular structure of the brown coal. This breakdown of cellular structure may cause the temperature of the dough to increase as it is being kneaded. Reaction between the alkali salt and the acidic brown coal may be exothermic, thereby further increasing the temperature of the dough as it is kneaded.

The dough must have a requisite softness and elasticity to be extruded into the shape of a monolith that retains its overall shape and geometry with sufficient integrity to resist unwanted deformation or cracking during subsequent steps. In some embodiments, the dough is made with a pliability akin to plasticine. A Dough that is too soft may not substantially maintain the monolith shape that they are extruded into. Similarly, a dough that is too firm may be too hard to extrude, or may be extruded with a compromised surface due to friction between the dough and the extruding die. A monolith with a surface such as this may be detrimental during subsequent steps and may be prone to cracking. In particular, the thin walls separating the internal channels of the monolith may be prone to cracking as the size of the monolith changes during conditioning and carbonisation.

The properties of the dough may be adjusted by the addition of supplementary additives to the dough. These supplementary additives may be configured to adjust the rheology, softness and elasticity of the dough as required such that the dough may be extruded into the shape of a monolith with sufficient integrity to maintain the overall shape and geometry during drying and carbonisation. The supplementary additives may include one or more of glycerol, paraffin oil, cellulose powders such as Methocel™ (a proprietary blend of methylcellulose and hydroxypropyl methylcellulose polymers), as well as other additives known to the art of extrusion. In some embodiments, the additives may be added to the dough after the brown coal and alkali salt have been kneaded together and have cooled.

Additional additives may also be included to the dough in order to customise or assist the performance of the subsequently formed monolith for various applications including adsorption, catalysis and conductivity. Examples of additional additives may include iron II and III compounds; and nitrogen containing compounds such as for example urea and melamine.

The brown coal and the alkali salt may be kneaded together until the temperature of the dough is raised to above about 35° C., preferably to about 40° C. to about 50° C. Such a temperature increase may occur by kneading the coal and the alkali salt together at between about 50 to 120 rpm for between about 1 and 2.5 hours to form a dough. In certain embodiments, the dough may be extruded at between about 30 rpm and 50 rpm. Where additives are used, they may be added after cooling the dough and subsequently kneaded further at speed of between about 30 to 50 rpm for a time of between about 15 to 45 minutes.

Once the dough has been formed, the dough may undergo extrusion where it is forced through a die into the shape of the honeycomb monolith. The extruded monolith may be termed the “green” honeycomb monolith to distinguish it from the monoliths that are end products of the subsequent processing steps. Although the green honeycomb monolith is formed substantially into the same shape and geometry as the eventual activated carbon honeycomb monolith as described herein, the green honeycomb monolith may be of a larger size due to the reduction in moisture and volatile content during drying and carbonization.

Green honeycomb monoliths may posses a high moisture content due to the moisture content of the brown coal used in its formation. As the moisture content of the monolith is reduced in the high temperature carbonization step, the monolith may substantially reduce in size. In certain cases, this reduction in size may lead to surface cracking of the monolith, or even breakages. In particular, the thin walls separating the internal passages within the monolith are prone to breaking as the monolith shrinks during processing. Where cracking is a problem, the green honeycomb monolith may undergo a conditioning step prior to a carbonization step. The conditioning step may reduce the moisture content of the green monoliths before the carbonisation step in order to limit the formation of cracks in the monolith during subsequent processing. The requirement for the conditioning step may depend on the vulnerability of the green monolith to form cracks, which may be influenced by the properties of the brown coal. In some embodiments it is sufficient to condition the green monolith at atmospheric conditions for a time to gradually remove moisture. In other embodiments, for green monoliths which are prone to cracking, the monoliths may be conditioned in a climate chamber where the humidity is progressively reduced. In some embodiments the green monoliths were placed in a climatic chamber where the humidity was progressively reduced from 85% to 50% to prevent the monolith from cracking as they dried. In some embodiments, the green monolith may shrink in size by up to about 50% during conditioning. The use of additives in the dough such as paraffin oil, glycerine and Methocel™ may all reduce the vulnerability to cracking and may therefore reduce the need for a conditioning step.

Once the dough has been extruded to form a green monolith and optionally conditioned, the monolith may be carbonized by heating the monoliths to high temperatures in the absence of oxygen. During carbonisation a significant portion of the green monolith may volatize, causing the monolith to shrink in size while substantially maintaining the shape and overall geometry of the monolith, including the internal channels. In some embodiments, between about 30% to about 50% of the monolith may volatize during carbonisation.

In certain embodiments, green monoliths were carbonized in an oven by raising the temperature at a rate of about 0.5° C./min until reaching at temperature of about 550° C. and then raising the temperature at a rate of 1° C./min until reaching 850° C. The monolith may then beheld at a temperature of about 850° C. for approximately 1 hour before the oven is switched off and the monoliths are allowed to cool slowly. In other embodiments the monoliths may be carbonized by raising the temperature to between about 850° C. to about 1100° C. at a rate of about 1° C./min before soaking the monolith at the final temperature for about an hour before allowing the monolith to cool. In some embodiments, it may not be necessary to cool the carbonised monoliths before they undergo an activation step.

The exact heating regime used to carbonise the monolith is a function of several factors including the composition of the brown coal precursor, the size and shape of the monolith such as the wall thickness between channels, the presence of additives and the degree of conditioning and the propensity of the monolith to crack or break. Accordingly, faster heating rates than those listed above may be suitable to carbonise certain monoliths without warping or cracking. In certain embodiments, the heating rate may range from about 0.5° C. to about 15° C./min and/or up to a temperature range of about 700° C. to about 1200° C. In certain embodiments an inert atmosphere may be provided during the carbonization process, for example a nitrogen environment.

The presence of the alkali salt in the green monolith may cause the monolith to undergo chemical activation during the carbonization step, thereby enhancing the surface area of the monolith. Before the monolith is carbonized, it has a surface area substantially similar to the brown coal precursor used in its formation. After carbonisation the surface area may be in the order of 660 m²/g and 450 m²/g as determined by CO₂ and N₂ adsorption respectively. Carbonization may also significantly increase the conductivity of the monolith, making them suitable for applications such as electrical swing adsorption.

In some embodiments, it may be desirable to further develop the surface of the monolith through physical activation. Physical activation may be performed by exposing the carbonized monolith to steam or CO₂ at high temperatures, for example, from between about 850° C. to about 1000° C. The carbonized monoliths may be held at these high temperatures for approximately 1 hour or until the monolith has become sufficiently active. Physical activation may be performed immediately after the monoliths have been carbonised to preserve the high temperatures developed during carbonisation.

In some embodiments, monoliths may be pre-oxidised to increase the oxygen content of the monolith prior to activation to improve monolith properties such as surface area. Pre-oxidation may occur before and/or after carbonization. In some embodiments, alkali components and/or other residual metal components may be removed before or after activation of the monolith by acid washing the monolith. If physical activation of the monolith is performed after the monolith has been chemically activated during the carbonization step, acid washing may occur after physical activation.

Without wishing to be bound by theory, it is though that chemical interaction between the brown coal and the alkali salt leads to a dough with certain advantageous properties. Brown coal has a high oxygen content, much of which is in the form of acidic and polar functional groups such as carboxylic acids and phenols. In a low pH environment, for example less than pH4.5, both intramolecular and intermolecular hydrogen bonds form between the acidic and polar functional groups binding the brown coal structure together and stabilizing it. If alkali salts are added to the brown coal at sufficient concentration and in a moist environment, the alkali salts will exchange for the hydrogen atom in the brown coal such that when dried, the polar functional groups are bridged by the alkali cation. This phenomenon of ion-exchange leads to an even stronger intermolecular and intramolecular network of electrostatic interactions. It is thought that the progressive development of this electrostatic bonding network helps to maintain the integrity of the monolith as it dries after being extruded.

### Example 1: Preparation of a Honeycomb Carbon Monolith

A dough was prepared using Victorian brown coal (VBC) as the carbonaceous precursor material. Raw VBC was mixed with the alkali salts NaOH and KOH and the supplementary additives paraffin oil and glycerol in combinations as set out in Table 1 below. Formulation A consisted of 1 kg of VBC and 350 g of NaOH. Formulation B consisted of 1 kg of VBC, 350 g of NaOH, 70 g of Methocel™, 70 g paraffin oil and 100 g glycerol. Formulation C consist of 1 kg of VBC and 350 g KOH. Formulation D consist of 1 kg VBC, 350 g KOH, 70 g Methocel™, 70 g paraffin oil and 100 g glycerol.

The mixtures were kneaded at between 50 to 120 rpm reaching temperatures of up to 50° C. to form a dough. The dough was extruded into the shape of a honeycomb monolith in a Brabender® twin screw extruder lab-compounder 20/40 with a speed of 40 to 50 rpm. Once the dough was extruded into the shape of a honeycomb monolith, the extruded products were then conditioned in a climate chamber at 25° C. by decreasing the humidity of the chamber by 5% every 5 hours to reach a final humidity of 50%.

The conditioned monoliths were carbonized in an oven at 850° C. for 1 hour under a controlled flow of nitrogen. The temperature of the over was ramped at a rate of 0.5° C./min until a temperature of 550° C. was reached, at which point the temperature was ramped at 1° C./min until the oven reached a temperature of 850° C. After the monoliths were carbonized in the oven was held for an hour at 850° C. under the flow of nitrogen, the atmosphere was switched to CO₂ gas to activate the surface of the monolith for 1 hour at 850° C. The external application of heat was then removed and the monolith was allowed to cool to room temperature. The resultant monoliths possessed good integrity and did not display any surface cracks. Furthermore, the monoliths displayed good surface area and conductivity characteristics after carbonization, which were further enhanced after activation.

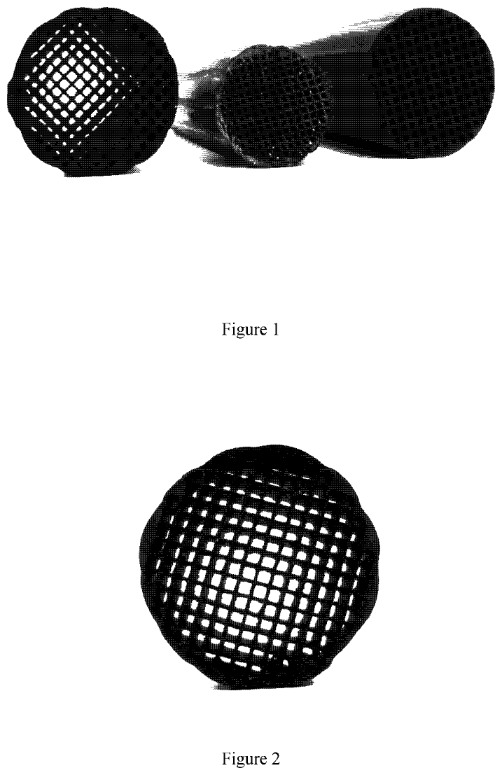

FIG. 1 shows three activated carbon honeycomb monoliths produced according to the method of example 1. The left most specimen has undergone carbonization and has a diameter of about 1.2 cm. The two rightmost specimens have been conditioned but not carbonized, and have a diameter of about 2.5 cm. The difference between these diameters is due to shrinkage during the carbonization step as hereinbefore described. FIG. 2 shows an end view of the carbonized monolith.

Also shown in Table 1 also compares the activated carbon honeycomb monoliths with certain prior art honeycomb monoliths prepared from selected polymer precursors.

TABLE 1
Surface areas determined for dried and carbonised VBC monoliths.Samples

| | | | CO₂ Surface area | | | Conductivity | | | |
|---|---|---|---|---|---|---|---|---|---|
| | Cell | Wall | (m²/g) | | | (Ω⁻¹ cm⁻¹) | | | Compressive |
| | density | thickness | Dried/ | | | Dried/ | | | strength |
| | (cells/in²) | (mm) | Conditioned | Carbonized | Activated | Conditioned | Carbonized | Activated | (MPa) |
| 1 kg VBC+ | 470 | 0.92 | 206 | 694 | 922 | ~2.5 × 10⁻⁶ | 98 | 121 | 35 |
| (formulation A) | | | | | | | | | |
| 1 kg VBC+ | 470 | 0.92 | | 707 | 1150 | ~2.5 × 10⁻⁶ | 135 | 148 | 20 |
| (formulation A) + | | | | | | | | | |
| 70 g Paraffin oil | | | | | | | | | |
| 1 kg VBC+ | 470 | 0.92 | 123 | 726 | 911 | ~2.5 × 10⁻⁶ | 160 | 210 | 37 |
| (formulation B) | | | | | | | | | |
| 1 kg VBC+ | 470 | 0.92 | 222 | 714 | 762 | ~2.5 × 10⁻⁶ | 112 | 155 | 28 |
| (formulation C) | | | | | | | | | |
| 1 kg VBC+ | 470 | 0.92 | | 700 | 1200 | ~2.5 × 10⁻⁶ | 227 | 171 | 40 |
| (formulation C) + | | | | | | | | | |
| 70 g Paraffin oil | | | | | | | | | |
| 1 kg VBC+ | 470 | 0.92 | 118 | 478 | 726 | ~2.5 × 10⁻⁶ | 85 | 104 | 25 |
| (formulation D) | | | | | | | | | |
| Polymer coated | 232 | | | | 680 | | | 0.035 | |
| cordierite HM | | | | | | | | | |
| Integral HM from | 50 | 1 | | | | | | | 17 |
| powdered coal | | | | | | | | | |
| Activated carbons | 20 | 0.9 | | | | | | | 13.7 |
| HM | | | | | | | | | |
| Carbon coated HM | 400 | | | | | | | | 8.6 |

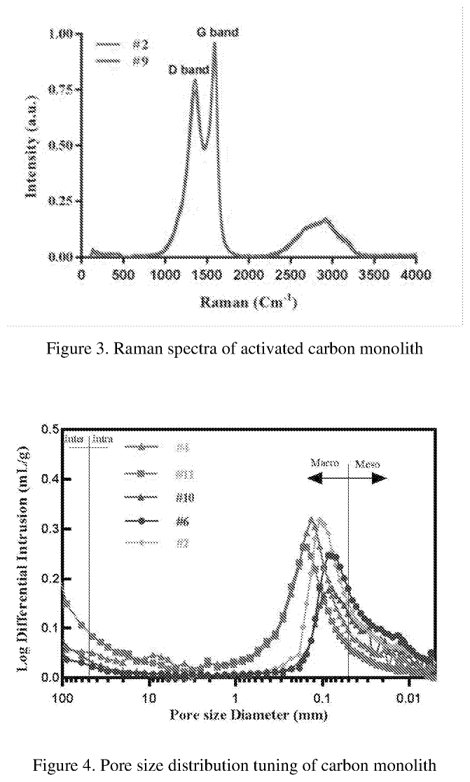

FIG. 3 displays a Raman spectra of activated carbon monoliths for example embodiments of the present invention. The results demonstrate a significant level of graphitization. For the samples of the activated carbon monoliths tested, the I_{G}/I_{D} ratio is below 0.8.

FIG. 4 illustrates the results of mercury porosimetry analysis on various samples of carbon monoliths in accordance with example embodiments. It can be seen that the pore size distribution of carbon monoliths can be tuned by treatment conditions.

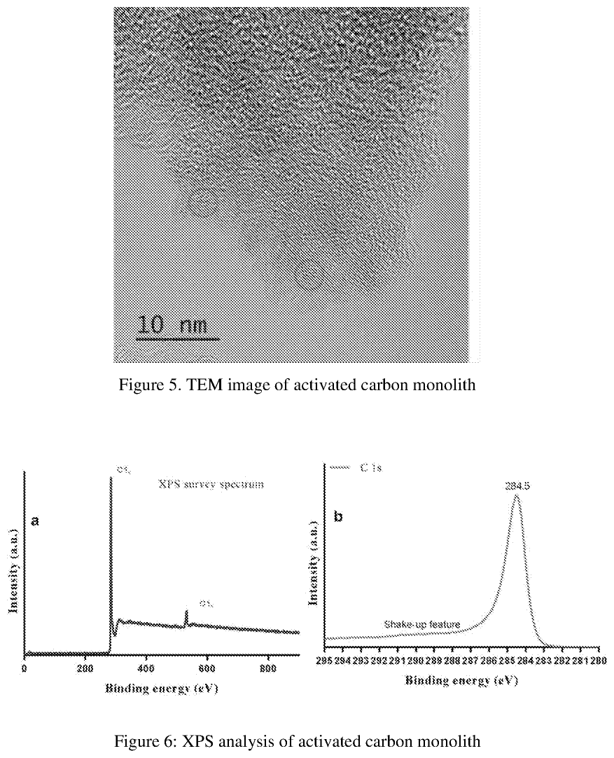

FIG. 5 depicts a Transmission Electron Microscopy (TEM) image of an activated carbon monolith in accordance with an example embodiment of the present invention. The TEM image shows that the activated carbon monolith have some graphite-like domains where there is alignment between carbon layers.

FIG. 6 displays an XPS analysis of an activated carbon monolith for an example embodiment of the present invention. The figure demonstrates the activated carbon monolith surface shows a) the presence of C and O atoms and b) shows that the carbon is substantially graphite with the main peak at 284.5 eV and with shake-up satellites.

### Example 2: Phenol Adsorption from Water

In this example, first the carbon monolith size distribution was tuned by specific carbonization conditions (2 h at 850° C. by heating rate 15° C.) and activation conditions (2 h at 900° C.) to improve its mesoporosity. The prepared carbon monolith was used to remove phenol from aqueous solution (40 ml) at a range of pH from 3 to 8. An maximum adsorption capacity of 159 mg/g was achieved at pH 6.

### Example 3: Phosphorous Adsorption from Water

In this example, the activated carbon monolith and iron incorporated carbon monolith were used for the removal of phosphorous (Na₃PO₄) from aqueous solution (20 ml) at a range of pH from 3 to 7. The carbon monolith showed a maximum 3.5 mg/g adsorption at pH 4 in initial experiments when no additive was applied. Those skilled in the art will understand that this level of adsorption is in the range of the reported adsorption capacity of phosphorous for activated carbon without additive and may be increased by increasing the amount of active metals such as iron, lanthanum and magnesium incorporated in the monolith.

### Example 4: Methylene Blue Dye Adsorption from Water

In this example, the activated carbon monolith is used to remove the methylene blue dye from aqueous solution (20 ml). An maximum adsorption capacity of 54 mg/g was achieved by an activated carbon monolith with surface area of 1120 m2/g.

Although much of the forgoing description focused on the specific embodiment of an activated carbon monolith formed from Victorian brown coal, it is to be understood that many other embodiments are encompassed by the subject matter disclosed herein, such as monoliths formed without internal channels and monoliths formed from other carbonaceous precursors including brown coal, lignite, peat and biomass.

The carbon monoliths of the present invention may be advantageous as they are do not require the addition of higher ranked coals or coal derivatives such as coal tar or pitch.

Many modifications will be apparent to those skilled in the art without departing from the scope of the present invention.

1. A process to produce a carbon monolith comprising the steps of:
(i) mixing a carbonaceous precursor material with an alkali salt to form a first mixture;
(ii) extruding the first mixture produced in step (i) into the shape of a monolith;
(iii) carbonizing the monolith produced in step (ii).

2. The process according to claim 1, wherein the carbon monolith is adapted with one or more internal channels.

3. The process according to claim 1, wherein the carbon monolith is a honeycomb monolith.

4. The process according to claim 1, wherein the carbonaceous precursor material has an oxygen content of at least 10 wt % and a moisture content of at least 20 wt %.

5. The process according to claim 1, wherein the carbonaceous precursor material is selected from brown coal, lignite, peat or biomass.

6. The process according to claim 1, wherein the carbonaceous precursor material is Victorian Brown Coal.

7. The process according to claim 1, wherein the carbonization step includes heating the monolith at a heating rate ranging from about 0.5° C. to about 15° C. per minute.

8. The process according to claim 1, wherein the carbonization step includes heating the monolith to a temperature of between about 700° C. to about 1200° C.

9. The process according to claim 1, wherein the carbonization step (iii) is performed in an inert atmosphere.

10. The process according to claim 9, wherein the carbonization step (iii) is performed in an atmosphere substantially comprising nitrogen.

11. The process according to claim 1, comprising a further step of physically activating the carbonized monolith produced in step (iii).

12. The process according to claim 9 wherein the further step of physically activating the carbonized monolith includes heating the carbonized monolith to a temperature of between about 800° C. and about 1200° C.

13. The process according to claim 11, wherein the activation step includes contacting the carbon monolith with an atmosphere comprised substantially of CO₂ and/or steam.

14. The process according to claim 1, wherein the first mixture further includes a supplementary additive to facilitate extrusion.

15. The process according to claim 14, wherein the supplementary additive is selected from glycerol, paraffin oil, methylcellulose powders and/or Methocel™.

16. The process according to claim 1, wherein the first mixture further includes an additional additive to customise the performance of the subsequently formed carbon monolith.

17. The process according to claim 16 wherein the additional additive is selected from iron II and III compounds and nitrogen containing compounds including urea and/or melamine.

18. The process according to claim 1, comprising a further step of conditioning the extruded dough produced in step (ii) before the carbonization step (iii).

19. The process according to claim 1, comprising a further step of pre-oxidizing the monolith before or after the carbonization step (iii).

20. The process according to claim 1, comprising a further step of acid washing the monolith after the carbonization step (iii).

21. The process according to claim 1, wherein the alkali salt is selected from any suitable salt of an alkali metal or an alkali earth metal or a combination of same.

22. The process according to claim 1, wherein the alkali salt is selected from a hydroxide, carbonate or bicarbonate salt of an alkali metal or an alkali earth metal or a combination of same.

23. The process according to claim 1, wherein the alkali salt is selected from LiOH, NaOH, KOH, Mg(OH)2 or Ca(OH)2 or a combination of same.

24. A carbon monolith formed by the process of claim 1.

25. A carbon monolith formed from an extruded mixture of an alkali salt and a carbonaceous precursor material with a moisture content of at least 20 wt % and a oxygen content of at least 10 wt %.

26. The carbon monolith according to claim 25, wherein the extruded mixture is carbonized and activated.

27. The carbon monolith according to claim 25, wherein the carbonaceous precursor material and the alkali salt are kneaded together prior to extrusion thereby facilitating ion-exchange between the carbonaceous precursor material and the alkali salt.

28. The carbon monolith according to claim 25, wherein the carbonaceous precursor material is Victorian Brown Coal.

29. The carbon monolith according to claim 25, wherein to any one of the preceding claims wherein the alkali salt is selected from any suitable salt of an alkali metal or an alkali earth metal or a combination of same.

30. The carbon monolith according to claim 25, wherein the alkali salt is selected from a hydroxide, carbonate or bicarbonate salt of an alkali metal or an alkali earth metal or a combination of same.

31. The carbon monolith according to claim 25, wherein the alkali salt is selected from LiOH, NaOH, KOH, Mg(OH)2 or Ca(OH)2 or a combination of same.
